(19) United States
(12) Patent Application Publication
(10) Pub. No.: US 2015/0163450 A1
(43) Pub. Date: Jun. 11, 2015

(54) VIDEO DISPLAY SYSTEM, SOURCE DEVICE, SINK DEVICE, AND VIDEO DISPLAY METHOD

(71) Applicant: Kabushiki Kaisha Toshiba, Tokyo (JP)

(72) Inventor: Kohei Miyoshi, Kumagaya Saitama (JP)

(21) Appl. No.: 14/624,373

(22) Filed: Feb. 17, 2015

Related U.S. Application Data
(63) Continuation of application No. PCT/JP2013/057164, filed on Mar. 14, 2013.

(51) Int. Cl. H04N 7/01

(52) U.S. Cl. CPC H04N 7/01

(57) ABSTRACT

According to an embodiment, a video display system includes a sink device and a source device. The source device transmits a video signal. The sink device has a plurality of operation modes regarding image processing, informs, when an operation mode is changed, the source device of information of a video format set in advance according to the changed operation mode and applies image processing according to the changed operation mode to the video signal received from the source device and outputs the video signal to a display.

### CROSS REFERENCE TO RELATED APPLICATION(S)

This application is a continuation application of PCT/JP2013/057164 filed on Mar. 14, 2013, the entire contents of which are incorporated herein by this reference.

### FIELD

An embodiment herein relates generally to a video display system, a source device, a sink device, and a video display method.

### BACKGROUND

Recently, a communication interface that transfers image and audio data at high speed from a source device to a sink device is becoming popular. A digital interface such as an HDMI (high definition multimedia interface) is one example of the communication interface as described above. Moreover, a new communication interface such as an MHL (mobile high-definition link) has been recently put to practical use.

Examples of the source device include a smartphone, a game console, a DVD (digital versatile disc) recorder, a set top box, and other AV sources (audio visual sources). Examples of the sink device include a television receiver (referred to as a television below), a projector, and other display units.

Upon receiving a video signal from the source device, the sink device applies various image processes to the received video signal, and displays the video signal on a display. Examples of the various image processes include various image quality improvement processes for displaying video with high image quality on a display, and a frame rate conversion process for displaying a video signal at a low frame rate.

Also, in some cases, the sink device has various operation modes. For example, a television has a plurality of operation modes such as a game mode and a movie mode. The sink device as described above is configured to execute predetermined processing according to the operation mode. For example, in the game mode, an operational feeling of a player is spoiled when a picture is displayed on a display at a delayed timing from a timing of picture output from a game console that is the source device. Thus, the television executes image processing specific to the game mode, such as video low latency processing in which a particular image quality improvement process is omitted, or a process of writing a video signal of an interpolation frame into a frame memory is reduced.

However, for example, when the source device outputs a video signal in a video format that requires processing such as the frame rate conversion process in a case in which the source device and the sink device are connected by the communication interface as described above and the sink device is set to a certain operation mode, the sink device may not be able to execute image processing specific to the operation mode since the processing exceeds processing capacity. This is because the source device does not have information about what kind of image processing the sink device performs according to the operation mode, and thus outputs the video signal in the video format as described above in some cases. Therefore, in consideration of the case as described above, the sink device is sometimes restricted from changing the operation mode in a state in which connection of the source device is connected.

For example, when a smartphone as an MHL source device outputs a video signal having a frequency of 30 Hz at 1080 p (a progressive system with 1080 pixels), a television as an MHL sink device executes the frame rate conversion process to convert the video signal to a video signal having a frequency of 60 Hz at 1080 p, and outputs the video signal to a display. However, for example, when a user sets the television to the game mode in order to play a game application of the smartphone on a large screen of the television, the television also needs to execute the image processing specific to the game mode, such as the video low latency processing, in addition to the frame rate conversion process. Thus, the processing exceeds processing capacity. Therefore, the television sometimes needs to be restricted, by its specification, from being changed to the game mode in a state in which the MHL source device is connected.

In such a case, it is possible to employ a method of causing the source device to recognize a video format in which processing specific to the operation mode of the sink device can be executed by exchanging EDID (extended display identification data) information between the source device and the sink device. However, in the method of exchanging the EDID information, a time-consuming procedure is required in which communication is performed after temporarily cutting transmission of a video signal by setting an HPD (hot plug detect) signal to LOW for a predetermined time period or more, and the transmission of a video signal is thereafter resumed. Thus, the method as described above has a problem that picture output based on the video signal from the source device is delayed in the sink device.

### BRIEF DESCRIPTION OF THE DRAWINGS

FIG. 1 is a configuration diagram of a video display system according to the present embodiment;

FIG. 2 is a block diagram illustrating configurations of a television 2 and a smartphone 3 of a video display system 1 according to the present embodiment;

FIG. 3 is a diagram illustrating a configuration example of an MHL reception section 12 of the television 2 and an MHL transmission section 32 of the smartphone 3 according to the present embodiment;

FIG. 4 is a diagram illustrating configurations of registers used in an MHL according to the present embodiment;

FIG. 5 is a flowchart illustrating an example of a processing flow at a time of changing a mode in the television 2 that is a sink device according to the present embodiment;

FIG. 6 is a timing chart for explaining a method for informing a video format using a scratchpad register in S2 according to the present embodiment;

FIG. 7 is a flowchart illustrating an example of a processing flow at a time of changing a video format in the smartphone 3 that is a source device according to the present embodiment; and

FIG. 8 is a diagram illustrating an example of information of a plurality of video formats set in advance for each mode according to the present embodiment.

### DETAILED DESCRIPTION

The present embodiment provides a video display system including: a source device configured to transmit a video signal; and a sink device having a plurality of operation modes regarding image processing, configured to inform, when an operation mode is changed, the source device of information of a video format set in advance according to the changed operation mode and configured to apply image processing according to the changed operation mode to the video signal received from the source device, and output the video signal to a display.

Hereinafter, an embodiment is described by reference to the drawings.

### (Entire Configuration)

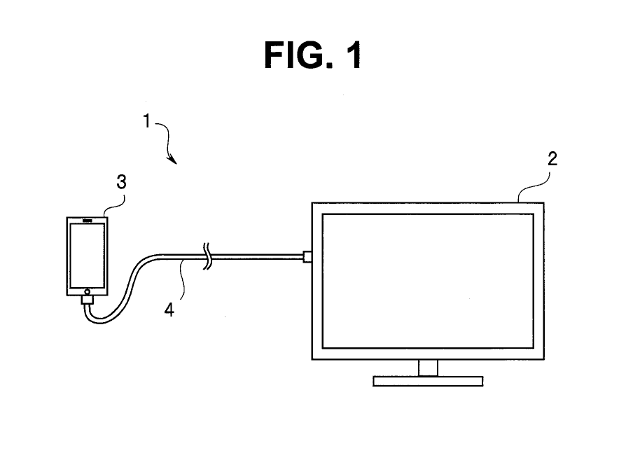

FIG. 1 is a configuration diagram of a video display system according to the present embodiment.

In the present embodiment, a video display system 1 includes a television 2 as an MHL sink device, and a smartphone 3 as an MHL source device, and the television 2 and the smartphone 3 are connected by an MHL cable 4 that is a communication cable. The smartphone 3 is a source device that outputs, that is, transmits a video signal.

An MHL is mainly an AV (audio visual) digital interface standard for mobile devices. In an MHL system, an MHL source device and an MHL sink device are connected by an MHL cable, and contents such as a moving picture, a still picture, and audio of the MHL source device are reproduced by the MHL sink device (AV stream, unidirectional). Also, control of readout of EDID (extended display identification data), authentication of HDCP (high-bandwidth digital content protection), register read/write, control with a remote controller, or the like between the devices is performed by transmitting and receiving a DDC (display data channel) command, and an MSC (MHL sideband channel) command (link control, bidirectional).

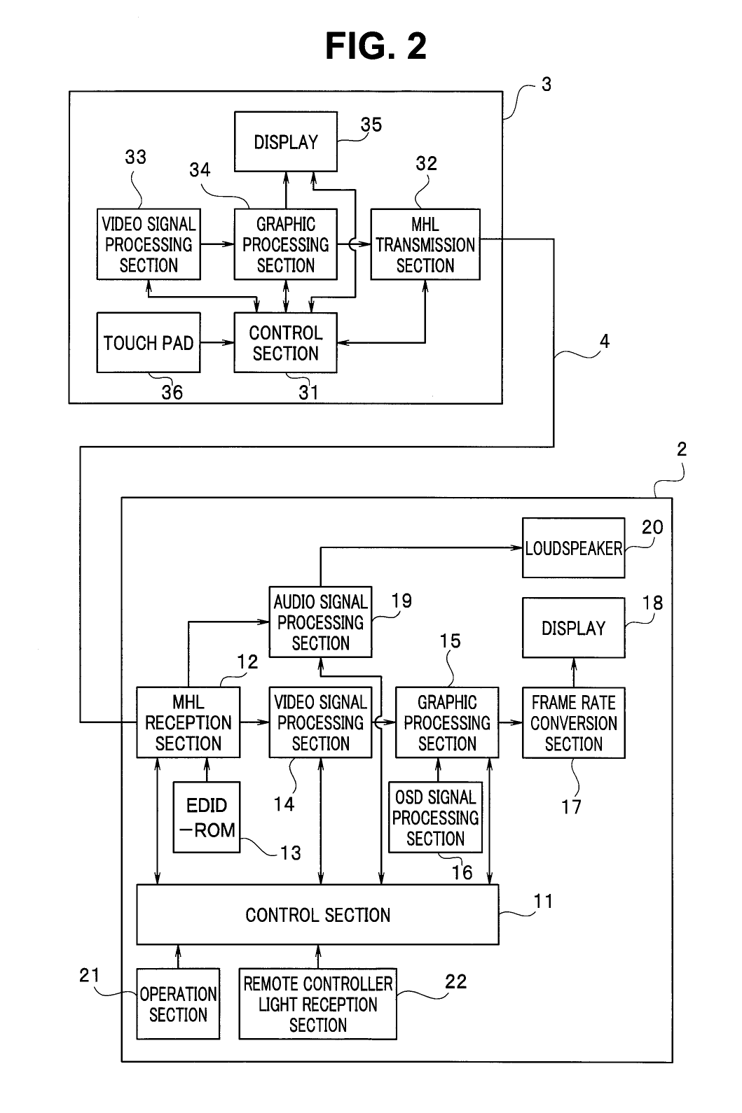

FIG. 2 is a block diagram illustrating configurations of the television 2 and the smartphone 3 of the video display system 1.

### (Configuration of the Television)

The television 2 includes a control section 11, an MHL reception section (MHL-Rx) 12, an EDID-ROM 13, a video signal processing section 14, a graphic processing section 15, an OSD (on screen display) signal processing section 16, a frame rate conversion section 17, a display 18, an audio signal processing section 19, a loudspeaker 20, an operation section 21, and a remote controller light reception section 22. Note that circuits such as an antenna and a tuner are omitted in FIG. 2.

The television 2 can not only receive a broadcast program and display the broadcast program on the display 18, but can also receive video signals in various video formats from an external device connected to the MHL reception section 12 and output a picture to the display 18.

Moreover, the television 2 has a plurality of operation modes such as a movie mode and a game mode. The television 2 executes image processing according to the operation mode. For example, in the game mode, an operational feeling of a player is spoiled when a picture is displayed on the display at a delayed timing from a timing of picture output from the source device. Thus, the television 2 executes image processing specific to the game mode, such as video low latency processing in which a particular image quality improvement process is omitted, or a process of writing a video signal of an interpolation frame into a frame memory is reduced.

The control section 11 includes a central processing unit (CPU), a ROM, a RAM, or the like, and is a processing section that stores and executes various programs for achieving entire control and respective functions of the television 2. When the CPU reads out and executes programs stored in the ROM, the entire control and the respective functions of the television 2 are achieved. Data of the respective sections of the television 2 are input to the control section 11, and the control section 11 outputs control signals to the respective sections.

The MHL reception section 12 is a circuit that receives data, such as image and audio, unidirectionally transmitted by communication based on the MHL standard from the MHL transmission section 32 (described below) of the smartphone 3 that is connected via the MHL cable 4. The MHL reception section 12 outputs image data to the video signal processing section 14, and outputs audio data to the audio signal processing section 19.

The EDID-ROM 13 is a storage section that stores EDID information. The EDID information can be read out by the MHL reception section 12.

The video signal processing section 14 is a circuit that processes predetermined various video signals with respect to the image data input from the MHL reception section 12. The video signal processing section 14 is a processing section that executes various image quality improvement processes or the like for high-quality display.

The graphic processing section 15 is a circuit that synthesizes an OSD signal generated by the OSD signal processing section 16 and the digital video signal processed in the video signal processing section 14 and outputs the obtained signal.

The frame rate conversion section 17 is a circuit that performs conversion of a frame rate.

The display 18 is a display unit such as a liquid crystal display panel, and displays an image of the video signal input from the frame rate conversion section 17 on a screen.

Therefore, the video signal processing section 14, the graphic processing section 15, and the frame rate conversion section 17 constitute an output section that applies image processing according to the operation mode to the received video signal, and outputs the video signal to the display 18.

The audio signal processing section 19 is a circuit that processes the audio data from the MHL reception section 12 and outputs an audio signal to the loudspeaker 20 such that audio is output from the loudspeaker 20.

The operation section 21 is an operation panel having various buttons. The remote controller light reception section 22 is a circuit having a light reception section that receives a remote operation signal from an unillustrated remote controller in a form of light. Various operation signals, such as an instruction to change the operation mode, are input to the operation section 21 and the remote controller light reception section 22, and the input operation signals are conveyed to the control section 11.

The control section 11 executes control according to the operation signals conveyed thereto. The operation signals include a mode instruction signal. When the mode instruction signal is input, the control section 11 controls the respective sections of the television 2 such that the respective sections are operated in an operation mode according to the input mode instruction signal. That is, the television 2 is a sink device having a plurality of operation modes regarding image processing.

As described below, the television 2 that is the sink device has a plurality of operation modes regarding image processing, and includes the MHL reception section 12 that receives the video signal transmitted from the smartphone 3 that is the source device. When the operation mode is changed, the television 2 informs the smartphone 3 of information of a video format set in advance according to the changed operation mode, applies image processing according to the changed operation mode to the video signal received from the smartphone 3, and outputs the video signal to the display 18.

### (Configuration of the Smartphone)

The smartphone 3 includes a control section 31, the MHL transmission section 32, a video signal processing section 33, a graphic processing section 34, a display 35, and a touch pad 36. Note that an antenna, a storage section that stores contents such as a movie and a game, are omitted in FIG. 2.

The control section 31 includes a central processing unit (CPU), a ROM, a RAM, or the like, and is a processing section that stores and executes various programs for achieving entire and respective functions of the smartphone 3. Data of the respective sections of the smartphone 3 are input to the control section 31, and the control section 31 outputs control signals to the respective sections.

The MHL transmission section 32 is a circuit that unidirectionally transmits data, such as image and audio, processed in the graphic processing section 34 under control of the control section 31 to the television 2 via the MHL cable 4 by communication based on the MHL standard.

The video signal processing section 33 is a circuit that generates and outputs the video signal. For example, the video signal processing section 33 generates and outputs a video signal of a game application when the game application is executed.

The graphic processing section 34 is a circuit that synthesizes a predetermined graphic image with the video signal received from the video signal processing section 33 and outputs the obtained signal.

The display 35 is a display unit such as a liquid crystal display panel, and displays an image of the video signal input from the graphic processing section 34 on a screen.

The touch pad 36 is an input section to which a user inputs various instructions, and an operation signal input to the touch pad 36 is input to the control section 31.

The smartphone 3 achieves various functions such as calling, messaging, reproduction of contents, and a game when the control section 31 executes a control program according to the input operation signal.

The smartphone 3 can convert the video signal into various video formats, and output the video signal from the MHL transmission section 32. For example, the smartphone 3 can output, from the MHL transmission section 32, the video signal in a format specified from various video formats such as a frequency of 60 Hz at 1080 i, a frequency of 60 Hz in a VGA format, and a frequency of 30 Hz at 1080 p in a case of an image of a game.

### (Configurations of the MHL Transmission Section and the MHL Reception Section)

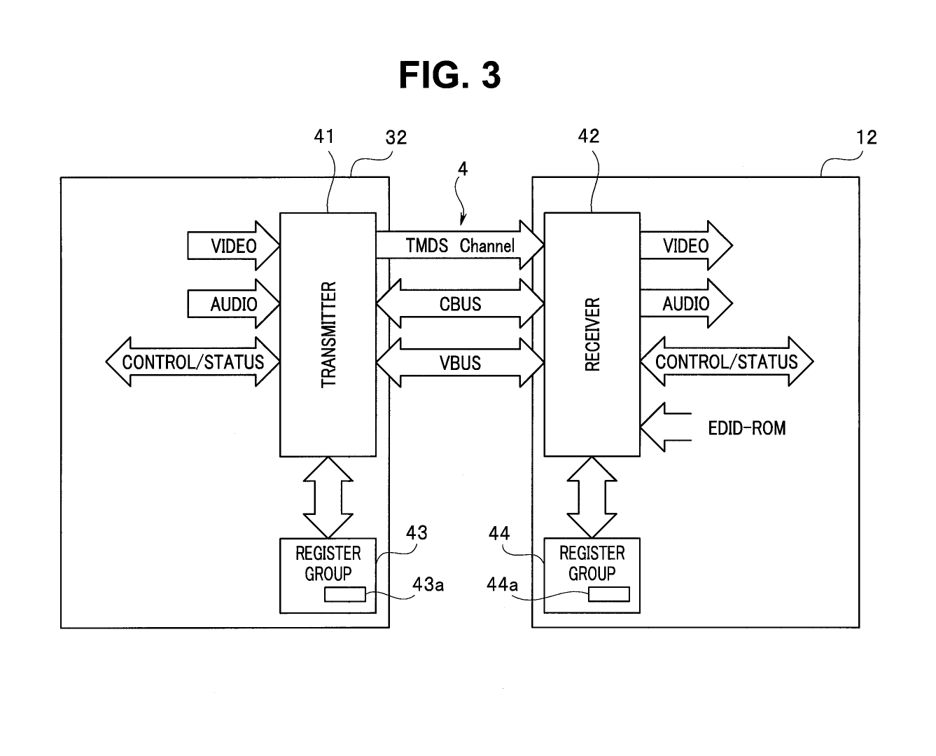

FIG. 3 is a diagram illustrating a configuration example of the MHL reception section 12 of the television 2 and the MHL transmission section 32 of the smartphone 3.

The MHL transmission section 32 includes a transmitter 41, and the MHL reception section 12 includes a receiver 42. The MHL transmission section 32 and the MHL reception section 12 are connected to each other via a pin (not shown) and the MHL cable 4 by five lines (MHL+, MHL−, CBUS, VBUS, GND). The “MHL+” and the “MHL−” for differential transfer of TMDS are one twisted pair, and transfer an AV stream and a synchronous signal (MHL clock) thereof.

The CBUS is used for bidirectionally transferring a DDC command and an MSC command. The DDC command is used for EDID readout or authentication of HDCP. Also, the MSC command is used for read/write to various registers, control with a remote controller or the like. The VBUS is used for supplying power of +5V from the MHL sink device to the MHL source device.

As described below, the transmitter 41 of the MHL transmission section 32 of the smartphone 3 that is the source device constitutes a reception section that receives an instruction to change a video format from the television 2 that is the sink device connected thereto, and a transmission section that transmits a video signal in the video format specified by the change instruction received by the reception section.

The transmitter 41 receives the instruction to change the video format by reading out the instruction to change the video format written by the television 2 into a scratchpad register 43a provided in the smartphone 3 that is the source device.

Moreover, the receiver 42 transmits information of a video format set in advance according to a changed operation mode to the smartphone 3 that is the source device when the operation mode is changed, as well as being a reception section that receives the video signal from the smartphone 3 that is the source device.

Furthermore, the MHL transmission section 32 has a register group 43 used in the MHL, and the MHL reception section 12 has a register group 44 used in the MHL. The register groups 43 and 44 respectively include scratchpad registers 43a and 44a.

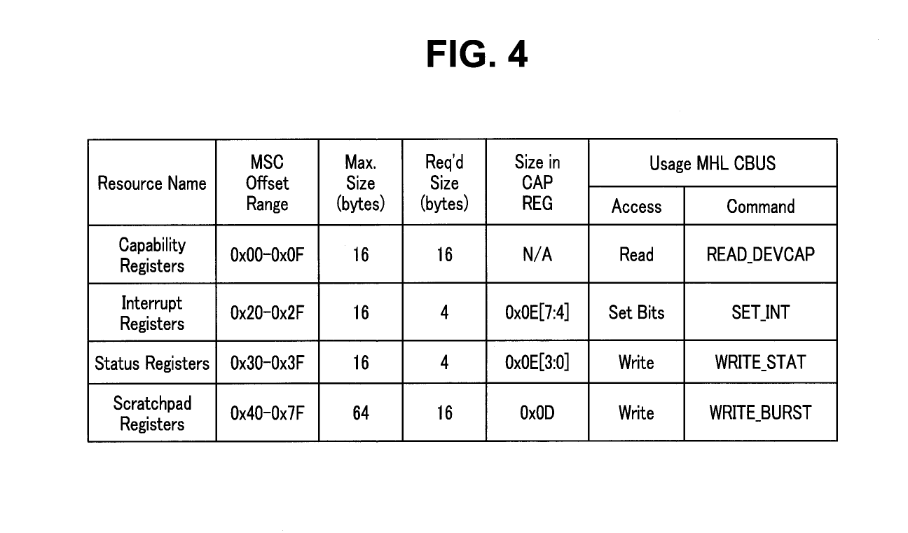

FIG. 4 is a diagram illustrating configurations of registers used in the MHL. Each of the register group 43 and the register group 44 has four types of registers, and can access each other by the MSC command.

Capability registers are registers indicating functions of the respective MHL devices. Functional information of the other-side device can be obtained by reading out the information by an “MSC READ_DEVCAP command”.

Interrupt registers are used for informing the other-side MHL device of an event. Information is set in the other-side interrupt register by an “MSC SET_INT command”.

Status registers are used for informing the other-side MHL device that it is possible to read the capability register of itself, and a status of a TMDS channel, or the like. Information is written into the other-side status register by an “MSC WRITE_STAT command”

The scratchpad registers 43a and 44a are used for sending out a message or data to the other-side MHL device. Information is written into the other-side scratchpad register by an “MSC WRITE_BURST command”.

In the present embodiment, the source device is informed of the information of the video format set in advance according to the operation mode changed in setting in the sink device by using the scratchpad register. That is, the sink device informs the source device of the information of the video format according to the operation mode by writing the information of the video format into the scratchpad register provided in the source device. Next, processing thereof is described.

### (Operation)

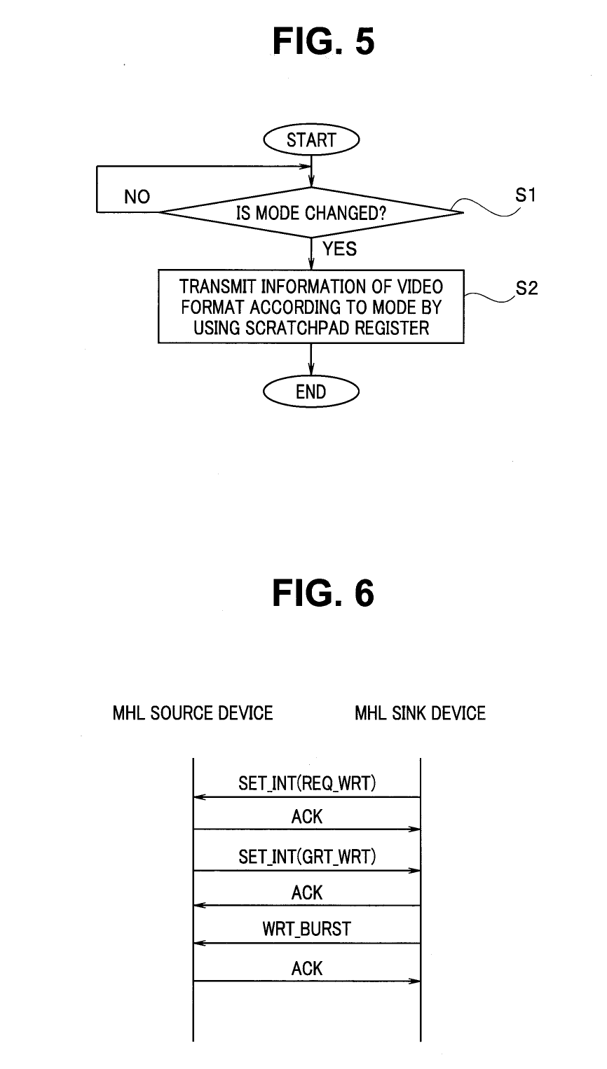

FIG. 5 is a flowchart illustrating an example of a flow of processing at a time of changing the mode in the television 2 that is the sink device. The processing in FIG. 5 is executed by the control section 11 of the television 2 that is the sink device when the smartphone 3 that is the source device is connected.

The control section 11 determines whether or not the mode is changed, that is, the instruction to change the operation mode is issued (S1). The instruction to change the operation mode is issued by a user by using a mode change instruction button or the like in the operation section 21 or the remote controller (not shown). Therefore, the control section 11 can determine whether or not the instruction to change the operation mode is issued based on an input signal into the operation section 21 or the like.

When the instruction to change the operation mode is not issued (S1:NO), no processing is performed. When the instruction to change the operation mode is issued (S1:YES), the control section 11 transmits the information of the video format set in advance for the changed mode to the smartphone 3 that is the source device by using the scratchpad register 43a so as to inform the smartphone 3 of the information (S2). That is, a process of S2 constitutes an informing section that informs the smartphone 3 that is the source device of the instruction to change the video format including the information of the video format set in advance according to the changed operation mode when the operation mode is changed. The process of S2 is described below in detail.

For example, it is assumed that a user changes setting of the operation mode of the television 2 to the game mode in order to play a game application of the smartphone 3 on a large screen of the television 2. It is assumed that the user instructs to change the mode from an operation mode in which a video signal of a normal broadcast program is received and displayed to the game mode.

When the operation mode of the television 2 is a broadcast program view mode before the change to the game mode, the television 2 receives a video signal in a video format having a frequency of 60 Hz at 1080 p (a progressive system with 1080 pixels) from the antenna, and outputs the video signal of 60 Hz at 1080 p to the display at a frequency of 60 Hz in the broadcast program view mode. In this case, the television 2 does not need to perform a frame rate conversion process, so that various image quality improvement processes can be executed.

However, in the game mode, the television 2 also needs to execute the image processing specific to the game mode, such as the video low latency processing.

Thus, when the operation mode is changed in setting to the game mode, the television 2 informs the smartphone 3 as the source device of information of a video format set in advance according to the game mode. The video format set in advance according to the game mode is a video format, for example, in which the television 2 does not need to execute the source frame rate conversion process on the video signal received from the smartphone 3 in the game mode.

For example, when the television 2 receives a video signal in a video format having a frequency of 60 Hz at 1080 i (an interlace system with 1080 pixels) from the antenna, the television 2 outputs the video signal having a frequency of 60 Hz at 1080 i to the display 18 at a frequency of 60 Hz. Thus, the television 2 does not need to perform the frame rate conversion process, and the image processing specific to the game mode, such as the video low latency processing, can be executed.

FIG. 6 is a timing chart for explaining a method for informing the video format using the scratchpad register in S2.

First, the control section 11 of the television 2 that is the MHL sink device transmits a write request interrupt command “SET_INT(REQ_WRT)” using a “SET-INT” command that is an interrupt command via the CBUS. The write request interrupt command “SET_INT(REQ_WRT)” is written into the interrupt register in the register group 43 of the MHL source device.

The control section 31 of the smartphone 3 that is the MHL source device receiving the write request command “SET_INT(REQ_WRT)” transmits an ACK signal for informing the television 2 on the other side of receiving the write request interrupt command via the CBUS.

Subsequently, the control section 31 of the smartphone 3 that is the MHL source device transmits a write grant interrupt command “SET_INT(GRT_WRT)” for granting write via the CBUS.

The control section 11 of the television 2 that is the MHL sink device receiving the write grant interrupt command “SET_INT(GRT_WRT)” transmits an ACK signal for informing the television 2 on the other side of receiving the write grant interrupt command via the CBUS.

The control section 11 of the television 2 that is the MHL sink device then transmits information including a predetermined command (for example, COF (change of format)) instructing to change the video format of the video signal to be output, and the information of the video format (for example, 1080 i, 60 Hz) by a write burst command “WRT_BURST” to the smartphone 3 via the CBUS, and writes the information into the scratchpad register 43a in the register group 43 of the MHL transmission section 32. That is, the sink device informs the source device of the information indicating a request to change the video format (COF) together with the information of the video format.

As shown in FIG. 4, the scratchpad register 43a has a condition that a size of 1 message is 16 bytes, and information up to 64 bytes can be written. Therefore, the control section 11 writes the above information including the predetermined command and the information of the video format by the write burst command “WRT_BURST” into the scratchpad register 43a in the register group 43 of the MHL transmission section 32 according to the condition.

As scribed above, the sink device writes the information of the video format into the scratchpad register 43a after the sink device transmits the write request interrupt signal (SET_INT(REQ_WRT)) to the source device, and the source device transmits the write grant interrupt signal (SET_INT(GRT_WRT)) to the sink device.

The control section 31 of the smartphone 3 that is the MHL source device informs the control section 11 of receiving the write burst command by transmitting an ACK signal for informing the television 2 on the other side of receiving the write burst command.

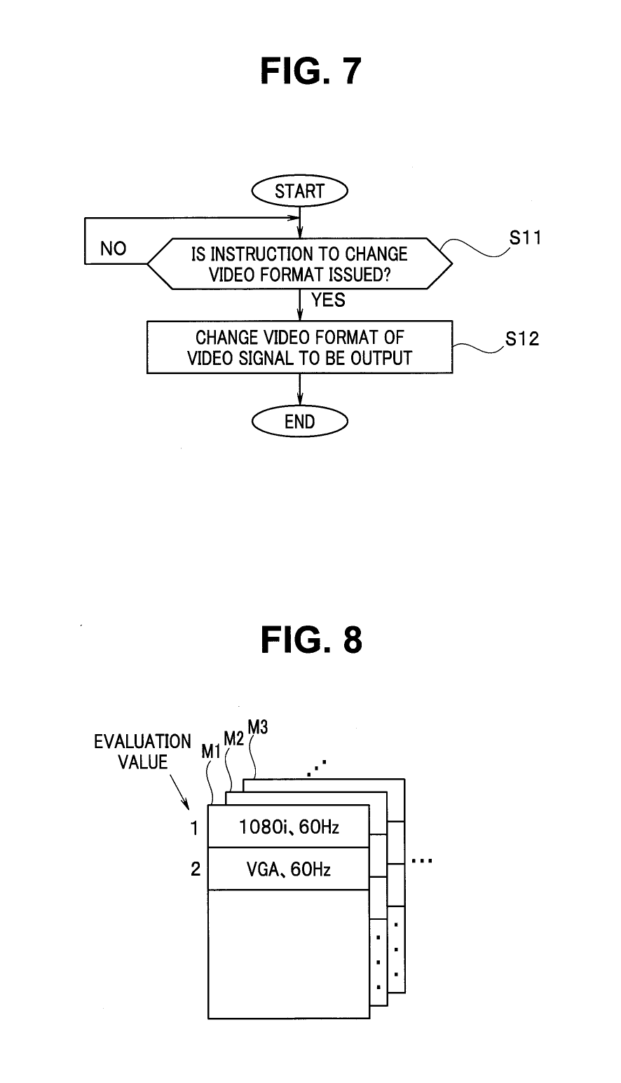

FIG. 7 is a flowchart illustrating an example of a flow of processing at a time of changing the video format in the smartphone 3 that is the source device. The processing in FIG. 7 is executed by the control section 31 of the smartphone 3 that is the source device when the television 2 that is the sink device is connected.

The control section 31 determines whether or not the instruction to change the video format is issued (S11). That is, the smartphone 3 that is the source device receives the change instruction from the television 2 that is the sink device by a process of S11. Whether or not the instruction to change the video format is issued is determined based on a written content into the scratchpad register 43a of the MHL transmission section 32. As described above, when the predetermined command (for example, COF (change of format)) is written therein, it is determined that the instruction to change the video format is issued.

When the instruction to change the video format is not issued (S11:NO), no processing is performed. When the instruction to change the video format is issued (S11:YES), the control section 31 changes the video format of the video signal to be output ( 12). More specifically, the control section 31 instructs the graphic processing section 34 to change the video format based on the information of the video format (for example, 1080 i, 60 Hz) written into the scratchpad register, and controls the respective sections so as to transmit the video signal in the video format specified by the received change instruction.

As described above, the television 2 informs the smartphone 3 of the video format of the video signal according to the operation mode by using the scratchpad register when the operation mode is changed. The smartphone 3 changes the video format so as to output the video signal in the informed video format. When the smartphone 3 that is the source device receives the information indicating the request to change the video format (COF), the smartphone 3 outputs the video signal in the video format indicated in the received information of the video format. The television 2 that is the sink device applies the image processing according to the changed operation mode to the video signal received from the smartphone 3 that is the source device, and outputs the video signal to the display 18.

As described above, the television 2 that is the sink device informs the smartphone 3 that is the source device of the information of the video format according to the mode by the MHL using the scratchpad register. Thus, the video format information can be quickly conveyed to the source device, and picture output based on the video signal from the source device can be quickly performed as compared to a case in which the EDID information is exchanged.

Therefore, in accordance with the video display system of the embodiment, it is possible to quickly output video from the source device in the sink device by quickly informing the source device of the information regarding the video format according to the operation mode of the sink device.

Note that the source device may be informed of a plurality of video formats in which processing can be performed according to the mode, and select one of the received plurality of video formats although the sink device informs the source device of one video format according to the mode in the aforementioned embodiment. In this case, as a selection criterion, the source device may select a most-highly evaluated video format based on a preset evaluation standard.

FIG. 8 is a diagram illustrating an example of information of a plurality of video formats set in advance for each mode. The control section 11 of the television 2 that is the sink device sets in advance and stores video format list information for each of a plurality of modes M1, M2, M3 and so on in a memory within the control section 11. FIG. 8 shows that, in the mode M1, processing specific to the mode M1 can be performed when the video format is “1080 i, 60 Hz” and “VGA, 60 Hz”.

When the setting change of the mode is performed, the control section 11 reads out the video format information set in advance for the mode, and informs the smartphone 3 from the MHL reception section 12. In a case of the mode M1 in FIG. 8, the control section 11 transmits the set information of the two video formats “1080 i, 60 Hz” and “VGA, 60 Hz” to the smartphone 3 that is the source device.

The control section 31 of the smartphone 3 that is the source device sets in advance and stores a predetermined evaluation value for each of the video formats in a memory within the control section 31.

The control section 31 of the smartphone 3 reads out prestored evaluation values for the received plurality of video formats from the memory, selects a video format having a highest evaluation value, and outputs a video signal in the selected video format. In the case of the mode Ml in FIG. 8, the control section 11 selects the video format “1080 i, 60 Hz” when the evaluation value of the video format “1080 i, 60 Hz” is “1”, the evaluation value of “VGA, 60 Hz” is “2”, and the one with a smaller evaluation value is more highly evaluated. The control section 31 controls the respective sections in the smartphone 3 so as to generate a video signal in the video format “1080 i, 60 Hz”, and output the video signal from the MHL transmission section 32.

Note that, for example, a video format received first may be simply selected from the received plurality of video formats without considering the evaluation values although the highly-evaluated video format is selected from the information of the received plurality of video formats in the smartphone 3 in the above example.

As described above, in accordance with the aforementioned embodiment, it is possible to provide the video display system, the source device, the sink device, and the video display method, capable of quickly outputting video from the source device in the sink device by quickly informing the source device of the information regarding the video format according to the operation mode of the sink device.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A video display system comprising:
a source device configured to transmit a video signal; and
a sink device having a plurality of operation modes regarding image processing, configured to inform, when an operation mode is changed, the source device of information of a video format set in advance according to the changed operation mode and configured to apply image processing according to the changed operation mode to the video signal received from the source device and output the video signal to a display.

2. The video display system according to claim 1, wherein the sink device informs the source device of the information of the video format by writing the information of the video format into a scratchpad register provided in the source device.

3. The video display system according to claim 2, wherein the sink device writes the information of the video format into the scratchpad register after the sink device transmits a write request interrupt signal to the source device, and the source device transmits a write grant interrupt signal to the sink device.

4. The video display system according to claim 2, wherein the sink device informs the source device of information indicating a request to change the video format together with the information of the video format.

5. The video display system according to claim 4, wherein the source device outputs, upon receiving information indicating the request to change the video format, the video signal in the video format indicated in the received information of the video format.

6. The video display system according to claim 1, wherein the information of the video format includes a plurality of video formats.

7. A source device comprising:
a reception section configured to receive an instruction to change a video format from a connected sink device; and
a transmission section configured to transmit a video signal in the video format specified by the change instruction received by the reception section.

8. The source device according to claim 7, wherein the reception section receives the instruction to change the video format by reading out the instruction to change the video format written by the sink device into a scratchpad register provided in the source device.

9. A sink device having a plurality of operation modes regarding image processing, the sink device comprising:
an informing section configured to inform, when an operation mode is changed, a source device of information of a video format set in advance according to the changed operation mode;
a reception section configured to receive a video signal from the source device; and
an output section configured to apply image processing according to the changed operation mode to the received video signal and output the video signal to a display.

10. The sink device according to claim 9, wherein the informing section informs the source device of the information of the video format by writing an instruction to change the video format into a scratchpad register provided in the source device.

11. A video display method comprising:
a sink device having a plurality of operation modes regarding image processing, informing, when an operation mode is changed, a source device of an instruction to change a video format including information of a video format set in advance according to the changed operation mode;
the source device receiving the change instruction from the sink device;
the source device transmitting a video signal in the video format specified by the received change instruction; and
the sink device applying image processing according to the changed operation mode to the video signal received from the source device, and outputting the video signal to a display.

12. The video display method according to claim 11, wherein the sink device informs the information of the video format by writing the change instruction into a scratchpad register provided in the source device.
